(19) United States
(12) Patent Application Publication
(10) Pub. No.: US 2013/0260853 A1
(43) Pub. Date: Oct. 3, 2013

(54) THROW ONE BACK BLACKJACK

(71) Applicant: SCORE GAMING LLC, Los Angeles, CA (US)

(72) Inventor: Merrill Sparago, Los Angeles, CA (US)

(73) Assignee: Score Gaming LLC, Los Angeles, CA (US)

(21) Appl. No.: 13/853,340

(22) Filed: Mar. 29, 2013

Related U.S. Application Data
(60) Provisional application No. 61/617,735, filed on Mar. 30, 2012.

(51) Int. Cl. G07F 17/32

(52) U.S. Cl. CPC G07F 17/3293
USPC 463/12

(57) ABSTRACT

A Blackjack style card game played with at least one standard deck of 52 playing cards. A player places a main wager and a side wager, and is then dealt two initial cards. The player may elect to receive additional cards into their hand per the traditional rules of Blackjack. If the sum of the player hand exceeds 21, the player's main wager is forfeited to the house. The player may elect to activate their side wager, and then choose one card to discard from their hand so as to reformulate the sum of their hand. After the dealer plays their hand, the player's side wager is resolved by comparing the sum of the dealer's hand to the reformulated sum of the player's hand, and settling the player's side wager accordingly.

### CROSS REFERENCE TO RELATED APPLICATIONS

This application claims priority to Provisional Patent Application No. 61/617,735 filed Mar. 30, 2012, the entire disclosure of which is hereby incorporated by reference and relied upon.

### BACKGROUND OF THE INVENTION

1. Field of the Invention

The current invention pertains to a casino game; more specifically, a game of Blackjack with the inclusion of a side wager which gives players additional options to play their Blackjack hand. 2. Related Art

Casino gaming, maintains a constant demand for novel games and additional wagering opportunities. Electronically implemented, computer driven interfaces, which allow players to interact with a gaming console in a virtual environment, have also extended the variety of platforms to offer novel casino games. Expanding the library of selection of electronically implemented games further enhances excitement, player options and profitability of games.

Additional options and methods of play are often instituted through addition of wagers that are added to standard games such as Blackjack. These wagers are known as side wagers and have shown success in live table games. Transforming novel side wagers into an electronic format adds another dimension to computer driven gaming.

Prior art describing the addition of a side wager to the traditional game of Blackjack can be found in multiple examples.

Side wagers can he divided into those that do not require strategy, i.e. do not require a strategy decision to win outside of the decision to place the wager, and those, which require an additional strategy in deciding how to play the side wager. Side wagers which require strategy add another level of decision making to the game thereby enhancing play.

One example of a side wager that is dependent on player strategy is found in U.S. Ser. No. 13/631,445, filed Sep. 28, 2012, which describes a method of play in which a player can place an additional side wager after seeing their final 2 card hand. The entire disclosure of U.S. Ser. No. 13/631,445 is hereby incorporated by reference and relied upon. According to the methods described therein, the player may place a side wager that is equal to the original wager and then must stand. If the player beats the dealer they will be paid 1:1 on both the original and side wagers.

However, what is still needed is further wagering opportunities that turn unfavorable situations into player wins when the player employs the correct strategy to the play of the side wager. Side wagers that allow players different options to play their hands but do not alter the standard method of dealing are also needed. In contrast, methods that change the dealing procedure—such as allowing players to take cards when the traditional rules of Blackjack dictate otherwise—can frustrate players who would have won their hand in the absence of an altered dealing procedure. Side wagers such as these are favorable for the house and the player as it increases the likelihood of player participation and enjoyment of the game. Further side wagers which allow players to win money when they lose their main wager provide an added level of satisfaction when playing the game.

### SUMMARY OF THE INVENTION

The invention contemplates live and electronically implemented versions of a method of playing a wagering game similar to Blackjack. The electronically implemented method comprises the step of providing an electronic gaming machine including at least one display screen configured to display images of playing cards, the electronic gaming machine including a non-transitory computer readable medium coded with instructions and executed by a processor to perform the steps of the invention. The live table game version instead provides a playing surface including playing positions for a dealer and at least one player. Playing positions are established for a dealer and at least one player. The game utilizes at least one standard deck of 52 playing cards with respective faces designated in ascending numerical sum 2-10, J, Q, K, A each in four suits. A numerical value is assigned to each card, the numerical value being equivalent to the face value for cards designated 2-10, ten for cards designated J, Q, K, and one or eleven for cards designated A. Play of the game method further includes accepting, a main wager from the player, whereupon the player and the dealer are each dealt two initial cards. The two initial player cards are arranged face-up, whereas for the dealer one initial dealer card is arranged face-up and the other initial dealer card face-down, Next, the player is invited to receive one or more additional cards into the player hand until either the player voluntarily stands on a numerical sum of card values less than 22 or the numerical sum of card values in the player hand exceeds 21. When the numerical sum of card values in the player hand exceeds 21, the player's main wager is forfeited to the dealer or house. The game method further includes the step of accepting a side wager from the player, and then inviting the player to discard one card in the player hand to reformulate the numerical sum of card values in the player hand less the value of the one discarded card, the reformulated numerical sum being less than 22. After the player has accepted the invitation to discard one card, the initial face-down dealer card is exposed so that the numerical sum of the dealer hand can be calculated. When the numerical sum of the dealer hand is less than a predetermined threshold, the dealer is required to receive an additional card followed by a repetition of the calculating and requiring steps. When the numerical sum of the dealer hand is equal to or greater than the predetermined threshold, the player's side wager is resolved. The step of resolving the side wager includes comparing the numerical sum of the dealer's hand to the reformulated numerical sum of the player's hand. and settling the player's side wager in favor of the player when the reformulated numerical sum of the player's hand is higher than the numerical sum of the dealer's hand. Conversely, when the numerical sum of the dealer's hand is greater than the reformulated numerical value of the player's hand but less than 22, the player's side wager is settled in favor of the dealer.

The present game method adroitly provides wagering opportunities that, when effectively executed, can turn unfavorable situations into player wins. The novel side wager of this invention allows players different options to play their hands but permit them to receive any additional cards and therefore does not alter the standard method of dealing. As a result, other concurrent players of the same game are not frustrated by an altered dealing procedure. The novel side wagers can be favorable for the house and the player as it increases the likelihood of player participation and enjoyment of the game. Further the present side wager allows players to win money only after they lose their main wager.

### BRIEF DESCRIPTION OF THE DRAWINGS

These and other features and advantages of the present invention will become more readily appreciated when considered in connection with the following detailed description and appended drawings, wherein:

FIG. 1 is an exemplary gaming machine used to play the modified Blackjack game and side wager according to one embodiment of the present invention;

FIG. 2 is an exemplary depiction of a computerized/virtual playing surface including a betting space for the side wager;

FIGS. 3 and 3A form a unitary flow diagram depicting the method of play for the modified Blackjack game and the side wager;

FIG. 4A is an exemplary depiction of the game play before the dealer plays their hand in a case were there are two players, neither of whom :qualify to play the side wager because neither players hand exceeds a sum total of 21;

FIG. 4B is a further progression of the game hands depicted in FIG. 4A, where the Dealer has a final hand total of 16 resulting in a push for Player 1 and a loss for Player 2;

FIG. 5A is another exemplary depiction of the play of the main Blackjack and side wager before the Dealer plays their hand in which there are two players, again neither of whom qualify to play the side wager as neither player has exceeded a card sum total of 21;

FIG. 5B is an exemplary depiction of the resolution of the main Blackjack wager from FIG. 5A, where the Dealer has a final hand total of 18 resulting in a push for Player 1 and a win for Player 2;

FIG. 61 is an exemplary depiction of the play of the main and side wager where Player 1 exceeds a total of 21 and elects to play the side wager enabling them to reform their hand for a new sum total of 19, and Player 2 stands on a hand total of less than 21 on the main wager therefore the side wager is returned;

FIG. 6B is an exemplary depiction of the resolution of the main Blackjack wager from FIG. 6A, where the Dealer has a final hand total of 18 and Player 1 has a final hand total of 19 that is paid 1:1 on the side wager, with Player 2 haying a final total of 19 and their main wager is paid at 1:1;

FIG. 7 is an exemplary depiction of the resolution of the main Blackjack wager where the Dealer has a final hand total of 19. Player 1 has a final hand total of 19 after electing to play the side wager but eventually loses against a Dealer 19 as the side wager loses on a tie), and Player 2 has a final total of 19 such that their main wager is a push against a Dealer 19;

FIG. 8 is an exemplary bonus pay table for side wagers that reach a total of 21; and

FIG. 9 is an exemplary depiction of a layout that may be used in live play between a Dealer and one or more Players.

### DETAILED DESCRIPTION OF THE PREFERRED EMBODIMENT

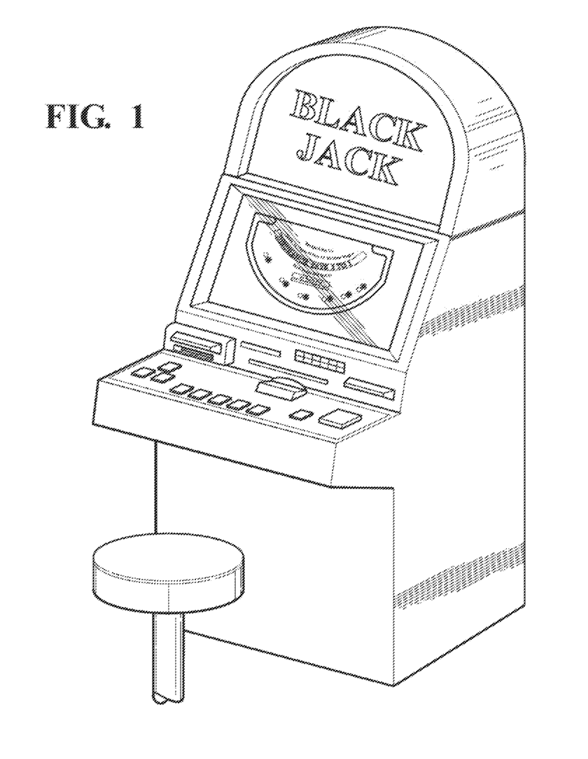

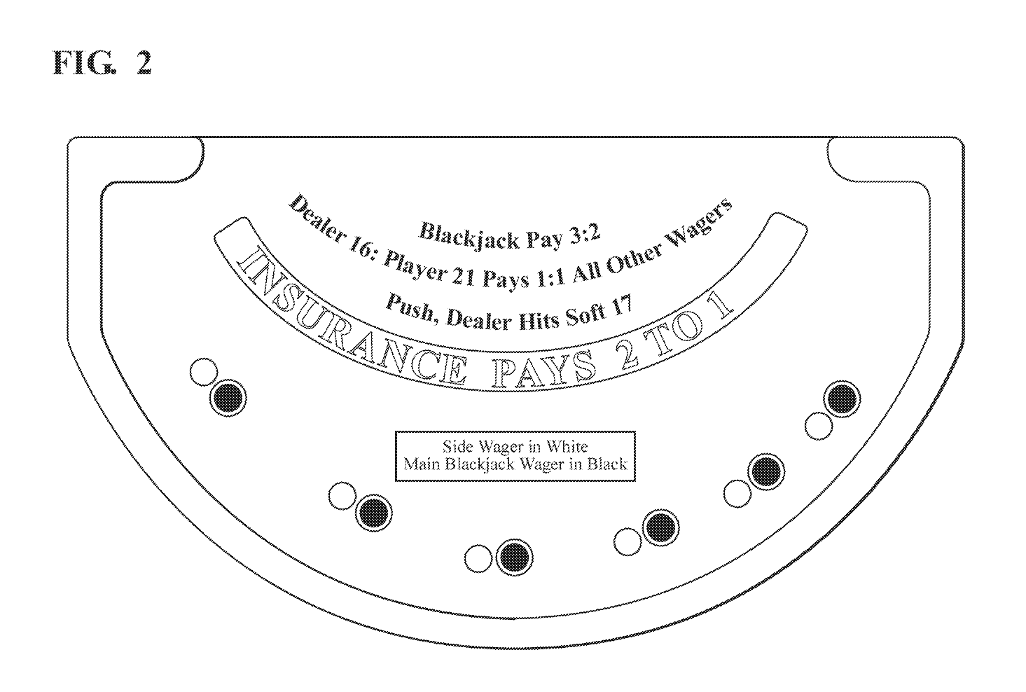

The novel side wager described herein is played in conjunction with the traditional. game of Blackjack either as a live table game or via an electronic gaining machine that is provided with a non-transitory computer readable medium coded with instructions and executed by a processor to perform the steps of the game method as described herein. An exemplary gaining machine is shown in FIG. 1. A gaining machine according to this invention may be configured for operation by a single player or by multiple players. The gaming machine may include a console where players sit and interact directly with the machine (FIG. 1) or alternatively can be programmed for online/internet or mobile play (not shown), or implemented through a smart gaining table where players participate live around a common computerized table fitted with touch-sensitive screens. In any of the electronic implementations, the gaming machine may include one or more display screens with the use of computerized and video technology that simulates the play of the game on a virtual Blackjack table. An enlarged view of the display screen, which may also be touch sensitive and serve as a graphical user interface for one or more of the proposed electronic embodiments, is illustrated in FIG. 2. The display screen(s) and/or other associated interfaces allow players to insert monies or cards which can be translated into credits for wagering and subsequent play of the game.

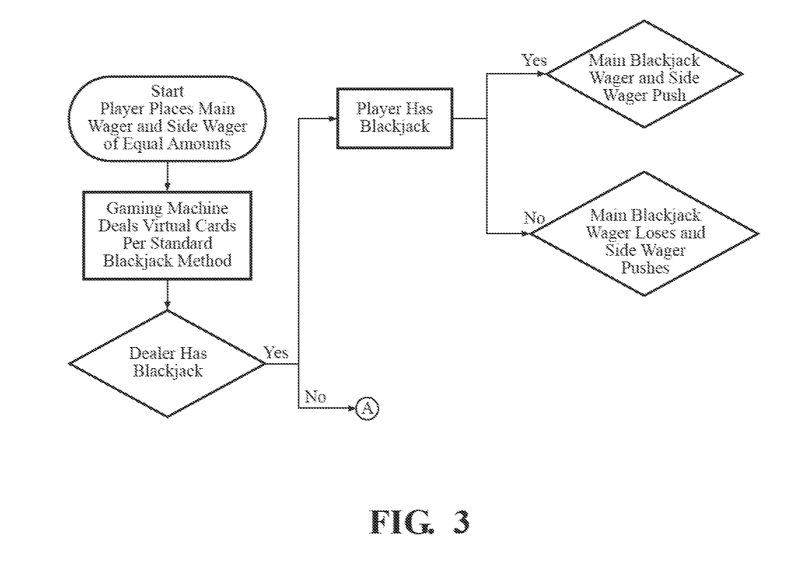

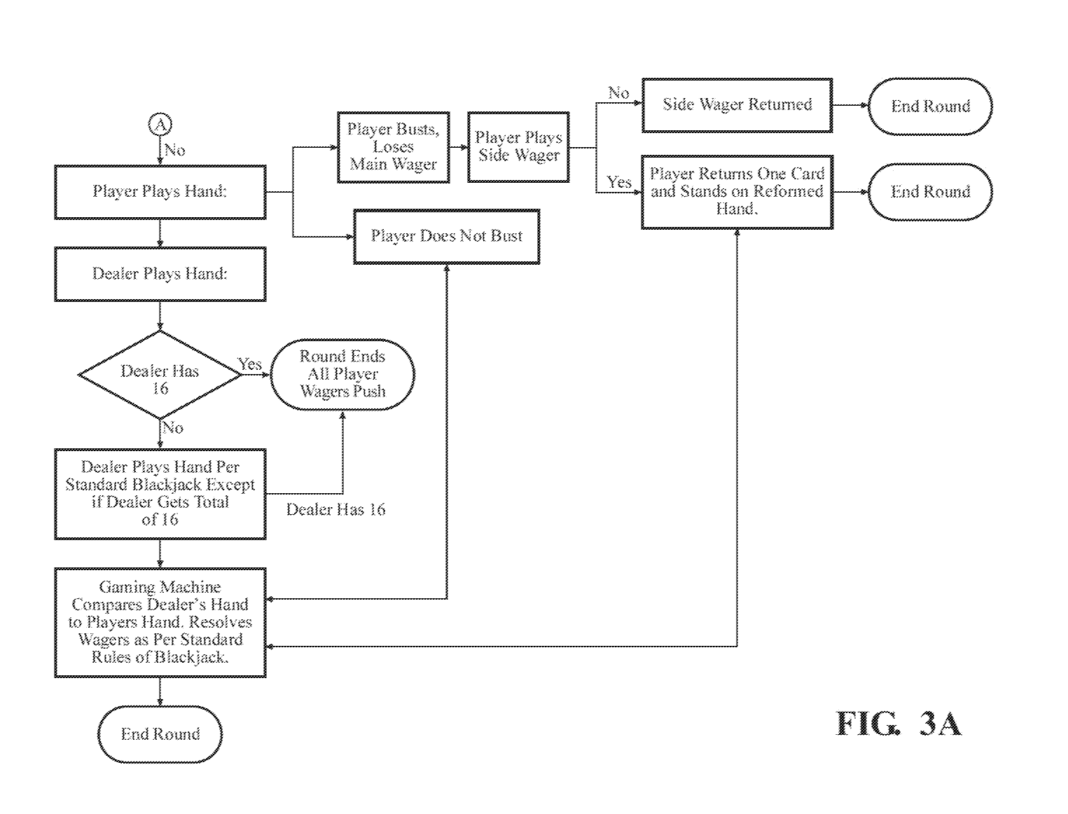

Play of the present game method is illustrated by way of flow diagram in FIGS. 3 and 3A. The game requires at least a single deck of standard playing cards excluding jokers. When implemented through an electronic environment, the non-transitory computer readable medium is coded to virtually provide reliable representations of the playing cards. Embodiments with multiple decks of cards (excluding jokers) dealt from a real or virtual shoe are also contemplated. As is common in Blackjack games, there is provision to mechanically or electronically shuffle the cards as needed.

It will be understood that a standard deck of 52 playing cards is composed of cards (or electronic representations of cards) having respective faces designated in ascending numerical sum 2-10, J, Q, K. A each in four suits. A numerical value is assigned to each card, with the numerical value being equivalent to the face value for cards designated 2-10 and ten for cards designated J, Q and K (i.e., Jack, Queen and King). The numerical value for cards designated A (Ace) is either one or eleven.

Blackjack, also known as Twenty-One or by various other names, is a popular card game, often quoted as the most widely played casino-banked game in the world. The traditional game is played with one or more standard decks of playing cards (excluding jokers). At the beginning of each round, the player places a bet and receives an initial hand of two cards. The basic rules of the game involve adding the value of the two initial card hand in hopes of being dealt a value of 21. If a value of less than 21 is dealt initially, the player may choose to be dealt single cards until they either reach a value of 21, or reach a lesser value the player feels comfortable holding at, or reach a value that exceeds 21. As between each player and the Dealer independently, the winner holds a hand with a value of or nearest to 21 without exceeding it. The complete rules of play for Blackjack are well documented and well known to those in the gaming field.

The modified game of the present invention follows generally the standard rules of Blackjack. At the start of the present modified game, however, each player places two independent wagers of the same amount (one wager for the main Blackjack wager and a second wager for the side wager). Players play their main wager as per the rules of standard Blackjack. If the player busts as a result of requesting one or more additional cards (i.e., the sum total of their hand exceeds 21), they will lose their main wager and then be presented with two options: a) Relinquish the main wager and terminate play of this hand, whereupon the second side wager will be returned to the player, or b) Relinquish the main wager and opt to play the second side wager.

Play of the second side wager entails the following steps: 1) Return any one card in the player's busted hand to form a new Blackjack hand from the remaining cards, and then 2) Stand on the new card sum total (calculated after by giving back a single card). According to the preferred rules of this modified game of the present invention, a Player will not be permitted to take any additional cards after reforming their hand. The newly formed hand (i.e., reformed by the selective removal of one card from an otherwise busted hand) will be compared to the dealer's final hand to determine the outcome of the side wager.

The second side wager can be made optional rather than mandatory at the start of play. If made optional, i.e., such that the player only places a single main wager to start the game, if the player busts the player will have one of two options: a) Relinquish the main wager and terminate play of this hand, or b) Relinquish the main wager and opt to play a second side wager by placing a second side wager of equal amount to the main wager. As before, play of the second side wager entails the following steps: 1) Return any one card in the player's busted hand to form a new Blackjack hand from the remaining cards, and then 2) Stand on the new card sum total. The newly formed hand will be compared to the dealer's final hand to determine the outcome of the side wager.

A first alternative embodiment of the present game method includes the option of relinquishing a card on a non-busted hand (i.e., where the total value is 21 or less) in addition to a hand that exceeds 21 (i.e., bust). Such an option may be attractive when the player's hand of three or more cards includes an Ace. Therefore, in order to play the side wager in this embodiment the player will forfeit their main wager and activate or make) the second side wager whereupon they may selectively relinquish one card in the hand and stand on the newly formed total. As before, however, a player will not be permitted to take any additional cards after reforming their hand. The newly formed hand will be compared to the dealer's final hand to determine the outcome of the newly formed hand.

In a second alternative embodiment of the present game method, the player will be able to place the side wager after completing the play of their main wager.

Turning now to a more detailed description of the method of play of the main Blackjack wager, the player will place a main Blackjack wager based on the table minimum and maximum through the interface between the player and the gaming console. Wagers will be placed before the cards are dealt. After the wager is placed, the virtual cards are distributed to the player and the dealer as per the standard method of dealing cards in the traditional game of Blackjack. The player will be able to play their hand based on the standard rules of Blackjack, which include: hitting, standing, surrendering and doubling down. Player Blackjacks will be paid at a recommended premium of 3:2. Players will also be able to take insurance as per the standard rules of Blackjack in the event the dealer's exposed card is an Ace. Winning insurance wagers may he paid at 2:1 as per the standard rules of Blackjack.

In the preferred game method, if the player elects to stand on a hand less than 21, they will not be able to participate in the play of the side wager and the side wager will be returned to the player. As an example, a player places the mandatory main and side wagers and is dealt a hand of a King and a nine for a total of 19. The player elects to stand and the side wager is therefore returned as the player's hand on the main Blackjack wager did not exceed a total of 21.

In the first alternative embodiment, the player will have the added option of relinquishing one card in their hand in the play of their main Blackjack wager on hands that total less than 21. In this embodiment, if the player elects to give up a card in their non-busted Blackjack hand, the player will forfeit their main Blackjack wager and the side wager will be activated. The method of determining the outcome and play of the side wager will be described in further detail below. In general however, the outcome of the side wager will be determined by comparing the dealer's final hand to the player's final hand in reference to the standard rules of Blackjack. As an example, a player places the mandatory main and side wagers which in electronic implementations may be though an interface with a gaming console. The player receives a hand of a 12, comprised of a Jack and a two. The dealer is showing an up card of 10. The player makes a verbal or hand gesture to the dealer. or in electronic implementations uses the interface, to “hit” and receives an Ace. Now the player has a total of 13 which remains a very weak hand against the dealer's 10 and therefore basic strategy would direct the player to hit, despite a high rate of busting. However, in this embodiment the player can adopt a novel strategy outside of hitting or standing and remove the two from their hand. This leaves the player with a 21 (10 and Ace) which is now a very strong hand. To do this, the player must forfeit their main wager and activate the side wager.

The outcome of the side wager will be determined as per the methods described now. The player will place the side wager based on the table minimum and maximum. The side wager cannot exceed the value of the main wager, and preferably (but not necessarily) is equal in sum to the main wager. Thus, if the player places $5 on the main wager, they may not place a wager greater than $5 on the main wager, and most preferably the side wager is also required to be $5. It should be appreciated that in certain embodiments, the side wager may be less than the main wager. In the preferred embodiment, the player optionally activates the side wager if the total of their Blackjack hand exceeds a sum total of 21 (i.e. the player busts). Since play of the side wager is optional, players will have one of two options in the event the player busts on the main Blackjack wager: forfeit their original cards and the original Blackjack wager and opt not to play the side wager (in which case the side wager will be returned to the player) or forfeit the cards and the original Blackjack wager and opt to play the side wager. In this latter case the side wager will be activated and then played immediately in the continuum of the game hand.

In the event the player opts to play the side wager, the player will select a single card to remove from their existing hand with the objective to make the highest hand that approaches but does not exceed 21. The player can do this independent of the number of cards they have in their busted hand. Once a card is forfeited the player must stand on the hand they have created. Players cannot draw any further cards. They can only use the cards they have already received before activating the side wager.

Therefore, the play of the side wager requires the player to give up one card and stand. This method is in place to preserve the integrity of the standard game of Blackjack where once a player has busted they may not receive any further cards. This is in contrast to side wagers or altered methods of play of the traditional game of Blackjack, which allow players to take cards after they have busted thereby changing the integrity of the standard game.

In general, player's resist rule changes where the numbers of cards that are traditionally dealt are changed. In traditional Blackjack after a player busts they cannot receive any more cards and play goes to the next player. Thus, in variations of Blackjack games where players receive a card and then can extrude this card to receive another changes the distribution of cards to subsequent players and to the dealer. As an example of a problematic scenario that is avoided by the present invention, in which a card distribution change adversely affects downstream play, assume that two players are at a table with a live or automated dealer. Player One receives a ten and a six for A total of 16. Player Two receives a ten and two for a total of 12. The dealer is exposing an eight. Player One then hits and receives a seven for a total of 23 and busts. Player One has the option (in this problematic scenario) to give up the seven and take a new card from the shoe and draws a nine. Player One busts again and the round is over for Player One. Player Two then hits on their hand and receives a five for a total of 17, which Player Two elects to stand on. The dealer reveals their unexposed card which is a ten for a total of 18 and Player Two loses. Player Two is exceedingly irritated. The nine should have been Player Two's card giving them a total of 21; a hand that would have beat the Dealer. By traditional rules of Blackjack, Player One would not have been able to draw the second card after busting, which in this case was the nine. Therefore, any rule change that disturbs the traditional distribution of cards for subsequent players is likely to create an extraordinarily frustrating situation for players.

In sharp contrast to the “problematic scenario” described above, the current side wager of the present game method overcomes the problem of players receiving cards after they bust by requiring the player to stand on their newly reformed hand. As a further example of the method of play of the present novel side wager, a player receives a hand of a ten and a two for a total of 12. The player elects to hit and receives a four for a total of 16. The player elects to hit again and receives a seven. The player has now exceeded 21 with a total of 23. The player has lost the main wager and opts to play the side wager. In this case the player gives up the two, and keeps the ten, four, and seven for a total of 21. The dealer has an exposed card of ten, thus play of the side wager will likely end up in a win, or at worst a push. Therefore, the best strategy decision in this case would be for the player to play the side wager. The player's hand is then compared against the final total of the. dealer's hand which in electronic implementations will be by a suitable computerized algorithm.

The method of play of the current side wager also introduces a new level of strategy and decision making, in the play of the side wager. To illustrate this point, consider a hypothetical in which a player is dealt a Jack and a six for a total of 16. The dealer has an exposed card of ten. The player elects to hit and receives a seven for a total of 23. The player has an option of playing the side wager; however the best hand the player can make is a 17, by relinquishing the six. Given the dealer has a ten exposed; a player 17 is unlikely to win as it is expected that the dealer's unexposed card is a 10 valued card for a total of 20. Therefore, the best strategy in this case would be to forfeit the main wager, and opt not to play the side wager as the player is likely to lose the side wager in addition to the main wager. The side wager will then be returned to the player.

Alternatively, if a player is dealt a ten and a two for a total of 12 and the dealer is showing a nine, the player's best strategy is to hit. In this case the player receives a King for a total of 22 and busts. In this case, the player would be wise to activate, the side wager and discard the two, leaving a total of 20 which is a strong hand against a dealer up-card of nine. hi this instance the player elects to play the side wager, discards the two and stands on the 20. The dealer reveals their unexposed card which is a nine for a total of 18, and the player beats the dealer.

The method of play of the Dealer's hand will now be described in detail. In one embodiment of the invention the dealer's hand is regulated to play per the standard rules of Blackjack with the following exception made in reference to the above-mentioned U.S. Ser. No. 13/631,445, which describes a method of play where the dealer stops the play of Blackjack if their hand reaches any total of 16. In this case, the numerical sum 16 is a predetermined threshold established by rule of the house. This modified rule is in distinction to the standard rules of Blackjack where the dealer will hit on any total 16 (i.e., where the predetermined threshold is instead 17). This particular rule change is one way to provide a mechanism to increase the house edge thereby freeing up room for (i.e., offsetting) the additional rule changes in the play of the current side wager. According to this rule variation, each player's main Blackjack wager is resolved by the standard rules of Blackjack with the following exception: If the dealer reaches any total of 16, the player's wager will push except if the player's hand is a total of 21, in which case the player will be paid 1:1 on the main Blackjack wager.

As an example, two players make an initial Blackjack wager and a side wager. Player One has a final hand total of 18 comprised of a King and an eight. Player Two has a final hand of 21 comprised of a King, a five and a six. The play of the Dealer's hand begins after the players complete their hands. In this case the Dealer has a five showing; the unexposed card is revealed which is a Queen for a total of 15. The Dealer draws or is electronically dealt) an Ace, giving the dealer a total of 16 ending the play of the Dealer's hand. Player One has a total of 18, therefore the Player One's wager will be returned, as if a push. Player Two has a total of 21 and therefore will be paid at the standard ratio of 1:1.

In the preferred embodiment, the side wager will be resolved by the standard rules of Blackjack with the following exceptions: 1) If the dealer reaches any total of 16, the player's side wager will push except if the player's hand is a total of 21, in which case the player will be paid 1:1 on the side wager; and 2) If the dealer does not have a total of 16, and the outcome of the player's and the dealer's hand result in a tie the side wager will be lost. If the dealer does not have as total of 16, and the outcome of the player's reformed hand exceeds the value of the dealer's hand or the dealer busts the player will win the side wager at a ratio of 1:1. If the dealer does not have a total of 16, and the outcome of the dealer's hand is 21 or less and exceeds the value of the player's reformed hand. the player will lose the side wager. If the player's reformed hand results in a total of 21, the player may be paid an exemplary bonus of 3:2 unless the dealer receives a Blackjack in which event the side wager will push.

In an alternative embodiment, the side wager will push in the event of a player and dealer tie as per the standard rules of Blackjack. The side wager may also be configured to lose in the event of a dealer Blackjack where the player does not have a Blackjack in their original hand. In this case the player will be able to make a traditional insurance wager on both the main Blackjack wager and the side wager in the event the dealer's exposed card is an Ace. Winning insurance wagers (i.e. if the dealer's unexposed card is a ten valued card) will be paid at 2:1 per the standard rules of Blackjack.

In a still further embodiment, the dealer will play by the standard rules of Blackjack and will hit when reaching a total of 16 (i.e., the predetermined threshold is 17). In this variation, which is actually more traditionally-based than the above-described preferred embodiment, the dealer will play by all of the traditional rules of Blackjack, and the main wager will be resolved as per the traditional rules of Blackjack. In the event the dealer has a Blackjack, the player will lose the side wager. The player will be able to place an insurance wager on the side wager when the dealer is showing an ace as per the traditional rules of Blackjack. If the outcome of the player's and the dealer's hand result in a tie the side wager will be lost. If the outcome of the player's hand exceeds the value of the dealer's hand or the dealer busts the player will win the side wager at a ratio of 1:1. If the outcome of the dealer's hand is 21 or less and exceeds the value of the player's hand, the player will lose the side wager. If the player's hand results in a total of 21 through the play of the side wager, the player may be paid an exemplary bonus of 3:2.

The description will now turn to an exemplary play and outcome of the Main Blackjack wager and side wager, where a player places a main wager and a side wager together before any cards are dealt. In an illustrative hypothetical example, two players each make a respective initial Blackjack wager and a side wager. Player One has a hand total of 18 comprised of a King and an eight. Player One elects to stand on the main Blackjack wager. Player Two has a King and a five on the first two cards (sum total 15). Player Two elects to hit and draws a six, giving a total of 21. Player Two then elects to stand on the main Blackjack wager. Therefore, the side wager has not been activated and is returned to each player in turn. Play of the Dealer's hand begins after the Players complete their hands. In this example, the Dealer has a five showing; the unexposed card is revealed which is a Queen for a total of 15. Compelled by the game. rules, the Dealer draws a card which is an Ace, giving the dealer a total of 16 ending the play of the dealer's hand. The outcome. of the main and side wagers are determined by comparing the dealer's final total. Player One has a total of 18 on the main Blackjack wager; therefore Player One's wager will push and be returned when the Dealer has any total of 16. Player Two has a total of 21 and therefore will be paid at the standard ratio of 1:1, even though the Dealer has a total of 16.

In another example, two players make an initial Blackjack wager and a side wager. Player One receives their initial cards which are a King and a six for a total of 16. Player Two receives their initial cards, which are a nine and a Jack for a total of 19. The Dealer's exposed card is a seven. Basic strategy dictates Player One take a card which is a seven for a total of 23. Player One's main wager is forfeited. Player One immediately elects to play the side wager, and chooses to relinquish the six. As a result, Player One's reformulated hand must stand with a total of 17. In general, playing the side wager when the result of the final hand will likely tie the dealer and therefore loose as per the preferred embodiment would not be a prudent strategy, and therefore underscores the need to play the side wager in an effective manner. Play then proceeds to Player Two who stands on their total of 19. Player Two's side wager is returned as it was not activated. Play then advances to the Dealer who reveals their unexposed card which in this case is an Ace, giving the dealer a final total of 18, where the Ace is ascribed a value of 11. The outcome of the main and side wagers are determined by comparing the Dealer's final hand total (18 in this example) to the respective Player totals. In this case Player One loses their side wager standing on 17 to the Dealer's 18. Player Two wins their main wager standing on 19 to the Dealer's 18.

In another example involving a single Player and a Dealer, the Player receives a two card hand comprised of a ten and a three. The Dealer's exposed card is a seven. The Player elects to hit and draws a nine for a total of 22. The Player loses their main wager and promptly elects to play the side wager. The Player relinquishes the three and stands on the new formed total of 19, representing a sound strategy as the Dealer is expected to have a total of 17. The Dealer exposes his hole card which is a King and must stand on the 17. In this case the Player's hand total (19) beats the Dealer's 17 and is paid at a ratio of 1:1.

The current invention gives the player an advantage by allowing them to reform a busted hand into a hand that is made by strategy rather than luck as in traditional Blackjack. In order to offset this advantage and preserve a sustainable house edge, methods must be employed to make the present invention commercially viable. These counter-active methods may include individually or in combination: Dealer stopping on a total of 16 and pushing all wagers except for a player total of 21; and the player losing the side wager on a dealer tie; and the player losing the side wager on a dealer Blackjack.

An additional aspect of novelty for the side wager of this present invention is that the player's total net win when activating and winning the side wager is $0. This occurs because the player's main and side wager must be of equal value, and by definition the player must lose the main wager in order to play the side wager. This therefore preserves a house edge and makes the side wager viable, given the player has the ability to reform their hand when they bust, however the dealer does not have this option, and must pay all remaining player wagers in the event of a bust.

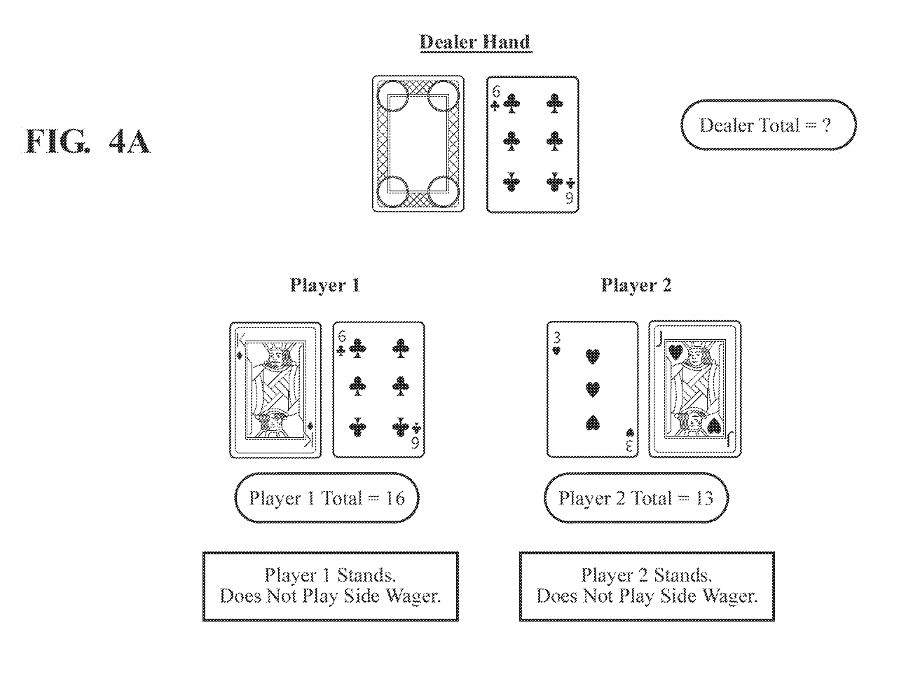

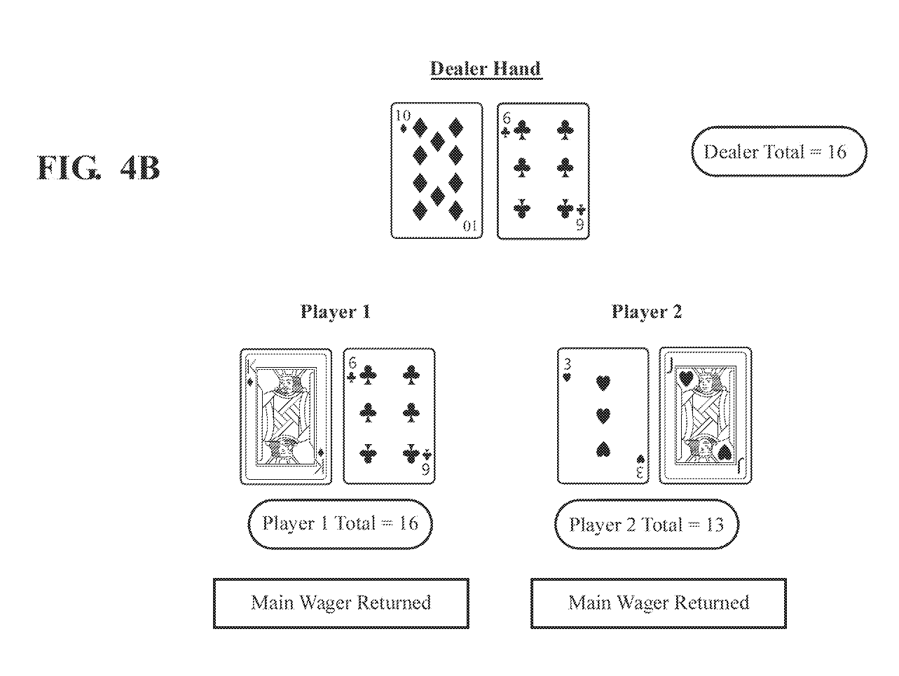

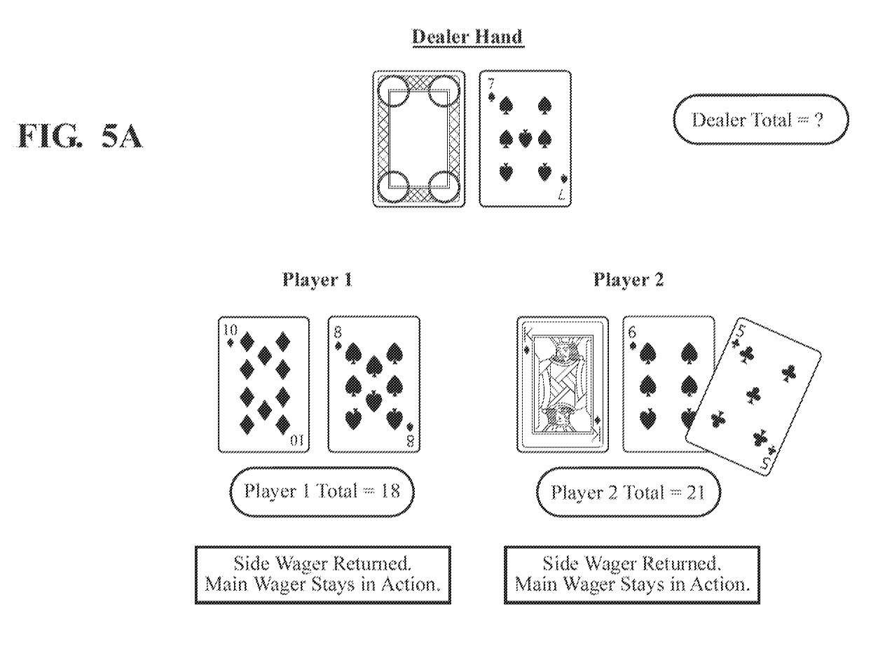

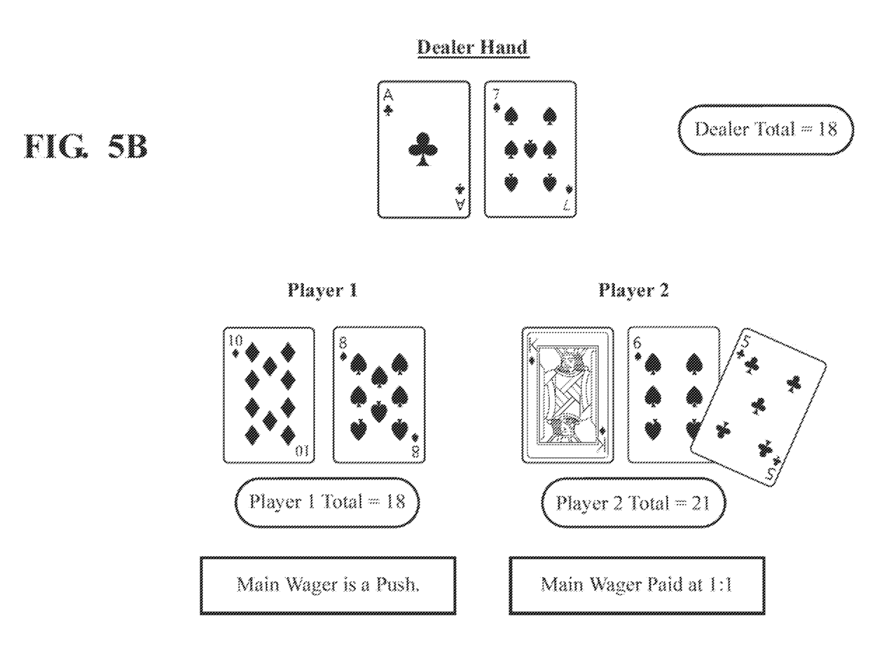

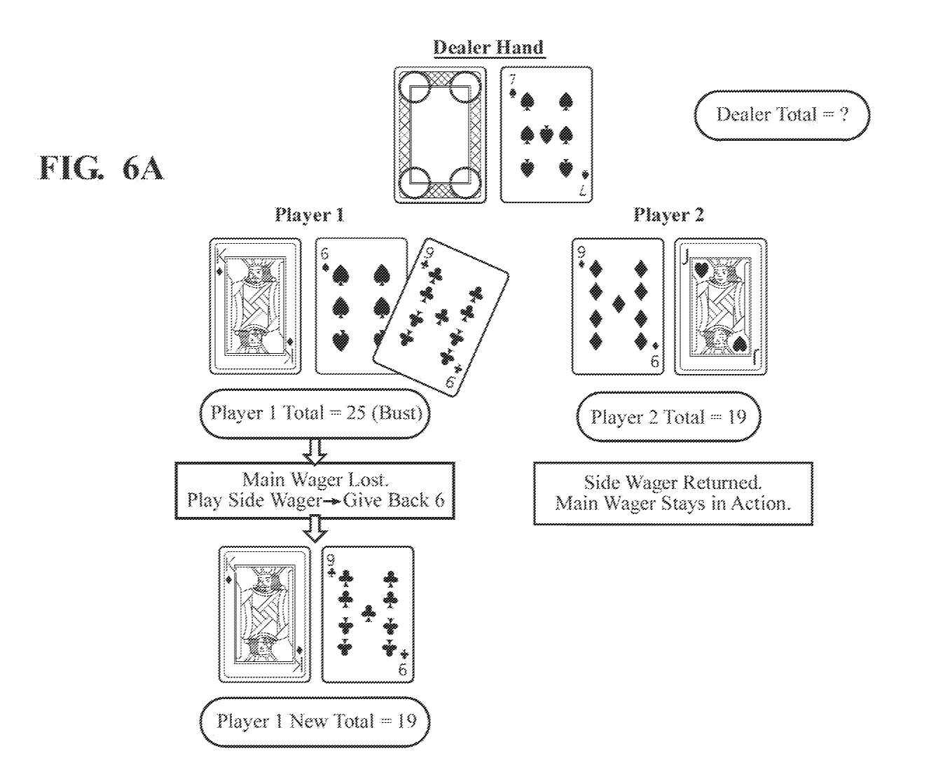

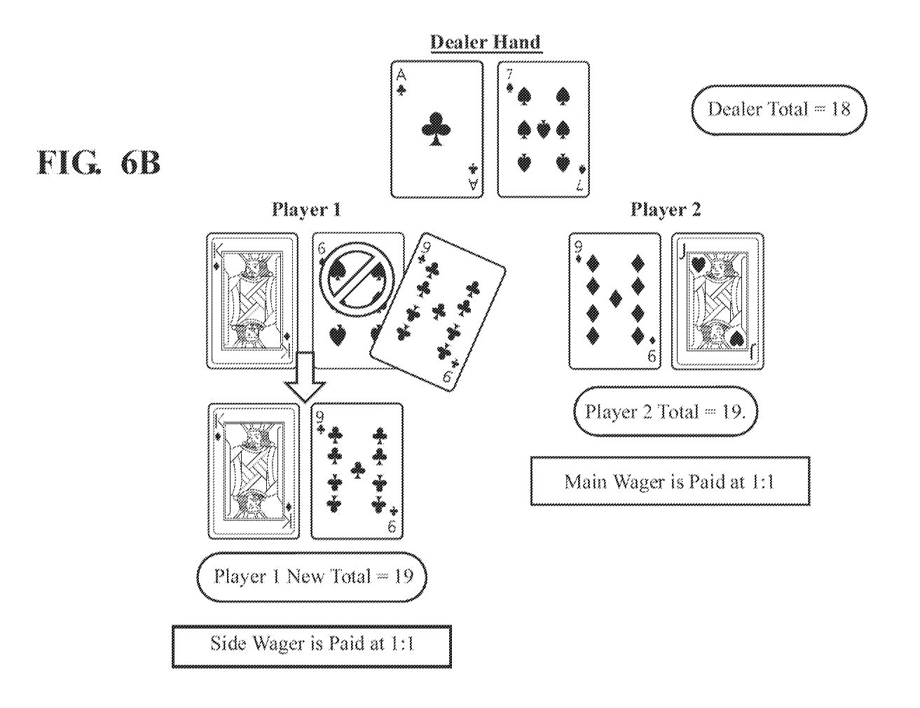

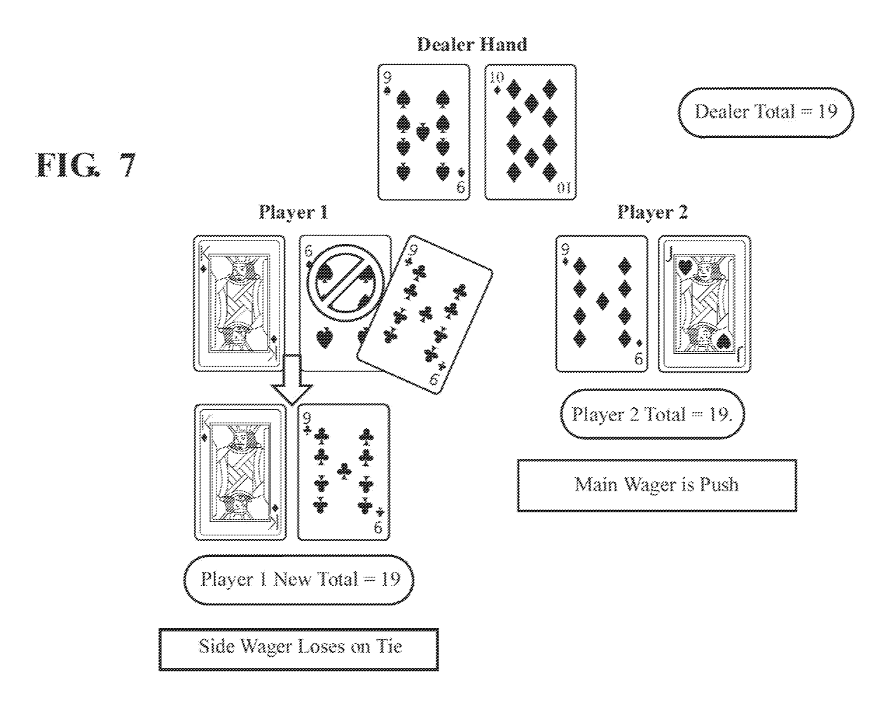

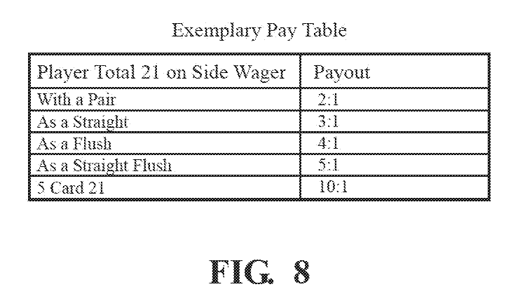

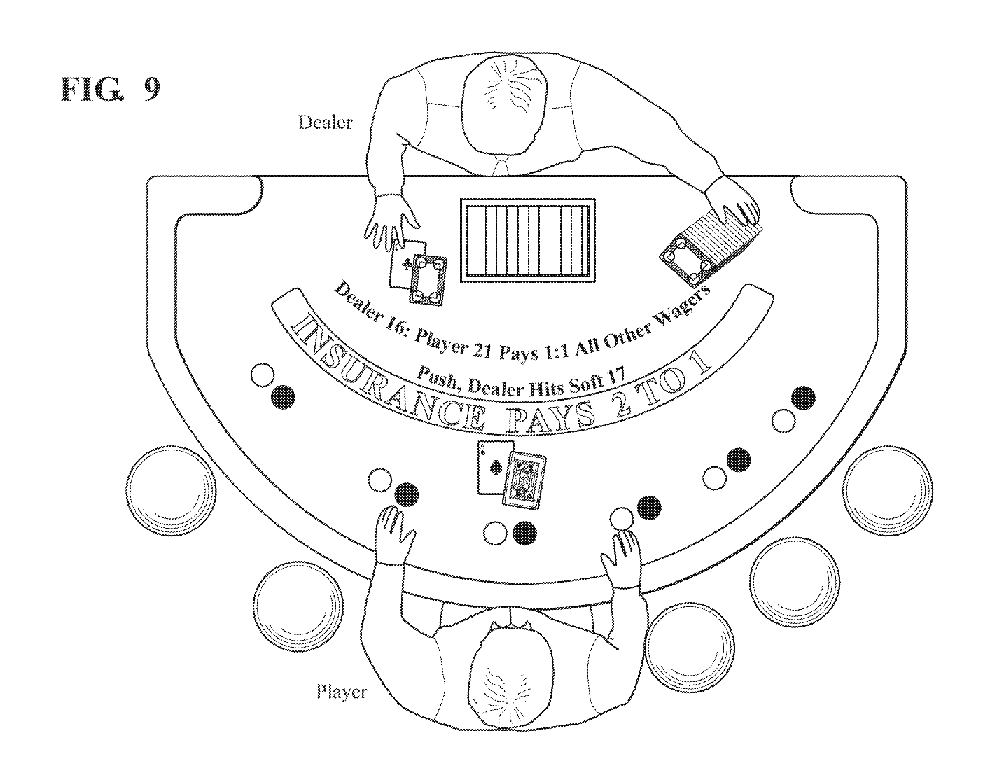

FIGS. 4A-7 provide still further examples of game play according to the present invention which will be readily understood by reference to the preceding descriptions.

Further methods can be implemented to make the side wager pay according to an established bonus pay table. To do this, the side wager may be lost in the event of a tie between the player and the dealer or on a dealer Blackjack as described above to incorporate the mandatory house edge. See for example a suggested pay table in FIG. 8. Accordingly, if the player for example loses their side wager to a dealer Blackjack, players may be paid a bonus such as 3:2 if the player can form a hand that reaches a total of 21 on the side wager. Bonuses may also be paid for certain combinations of 21 which include those with a pair, three of a kind, straight, flush, straight flush or other variations of poker hands.

As an example, a player places the main Blackjack wager and the side wager and is dealt a seven and a two on their initial cards for a total of 9. The dealer is showing a nine, this the player elects to hit as per basic strategy and draws a seven for a new total of 16. The player elects to hit again and draws a seven for a total of 23 and a bust thereby losing the main Blackjack wager. The player elects to play the side wager and relinquishes the two giving a total of 21 comprised of three 7's. This would qualify for a bonus per the Exemplary Pay Table of FIG. 8 as the player reached a total of 21. A further bonus may be paid as the player's total of 21 was comprised on a three of a kind. Other options that could be available to increase the house edge might include Blackjacks paid at 6:5 rather than the traditional 3:2.

The scope of the current invention fully contemplates play of the modified Blackjack game and side wager on a gaming table with live players and optionally a live dealer, as depicted in FIG. 9. The gaming table includes wagering areas for the main and side wagers in either printed or electronic formats on the playing surface, tangible or electronic cards and chips as per standard casino gaming arrangements. The gaming table may include an electronic display configured to automatically display vital information to players such as the dealer's action (strategy), pay tables, etc. Further machine implementations may be incorporated into a live table version of the present game, including such features as a dealing shoe, a shuffling machine, card scanner(s), digital readout(s), illuminated sign(s), surveillance mechanisms, etc.

In a live table game, the dealer or a computer-implemented program representing a dealer, will distribute the cards as per the standard rules of Blackjack on a layout designed specifically for play of the modified game. The layout may be formed on an electronic display screen. The game will use at least a single deck of standard playing cards excluding jokers. Play and resolution of the main and side wager are consistent with those methods and options described above.

The foregoing invention has been described in accordance with the relevant legal standards, thus the description is exemplary rather than limiting in nature. Variations and modifications to the disclosed embodiment may become apparent to those skilled in the art and fall within the scope of the invention.

What is claimed is:

1. An electronically implemented method of playing a wagering game similar to Blackjack using images of playing cards, comprising:
providing an electronic gaming machine including at least one display screen configured to display images of playing cards; the electronic gaming machine including a non-transitory computer readable medium coded with instructions and executed by a processor to perform the steps of
establishing playing positions on the display screen for a dealer and at least one player;
producing electronic images of at least one standard deck of 52 playing cards with respective faces designated in ascending numerical sum 2-10, J, Q, K. A each in four suits; assigning a numerical value to each card, said numerical value being equivalent to the face value for cards designated 2-10, said numerical value being ten for cards designated J, Q, K, and said numerical value being one or eleven for cards designated A;
accepting a main wager from the player,
dealing the player and the dealer each two initial cards, said dealing step including arranging on the display screen the two initial player cards face-up, said dealing step including arranging on the display screen one initial dealer card face-up and the other initial dealer card face-down.
inviting the player to receive one or more additional cards into the player hand until either the player voluntarily stands on a numerical sum of card values less than 22 or the numerical sum of card values in the player hand exceeds 21,
forfeiting the player's main wager when the numerical sum of card values in the player hand exceeds 21,
accepting a side wager from the player, and then inviting the player to discard one Card in the player hand to reformulate the numerical sum of card values in the player hand less the value of the one discarded card, the reformulated numerical sum being les than 22,
exposing on the display screen the initial face-down dealer card,
calculating the numerical sum of the dealer hand, when the numerical sum is less than a predetermined threshold then requiring the dealer to receive an additional card and repeating said calculating and requiring steps, and when the numerical sum is equal to or greater than the predetermined threshold then resolving the side wager,
said step of resolving the side wager including comparing the numerical sum of the dealer's hand to the reformulated numerical sum of the player's hand, and settling the player's side wager in favor of the player when the reformulated numerical sum of the player's hand is higher than the numerical sum of the dealer's hand, and settling the player's side wager in favor of the dealer when the numerical sum of the dealer's hand is greater than the reformulated numerical value of the player's hand but less than 22.

2. The method of claim 1, wherein the main wager has a monetary value and the side wager has a monetary value less than the value of the main wager.

3. The method of claim 1, wherein the main wager has a monetary value and the side wager has a monetary value equal to the value of the main wager.

4. The method of claim 1, wherein said step of accepting the side wager occurs prior to said step of dealing the player and the dealer each two initial cards, and further including returning the side wager when the player declines to discard one card in the player hand to reformulate the numerical sum of card values.

5. The method of claim wherein said step of inviting the player to discard one card in the player hand is permitted only when the reformulated numerical sum of the player hand exceeds 21.

6. The method of claim 1, wherein said step of resolving the side wager includes settling the main wager in favor of the player when the reformulated numerical sum of the player's hand is 21 and the numerical sum of the dealer's hand is exactly 16.

7. The method of claim 1, wherein said step of resolving the side wager includes comparing the numerical sum of the dealer's hand to the reformulated numerical sum of the player's hand, and settling the side wager in favor of the player when the reformulated numerical sum of the player's hand is higher than the numerical sum of the dealer's hand and less than 22 and the numerical sum of the dealer's hand is not 16.

8. The method of claim 1, wherein said step of resolving the side wager includes pushing the side wager when the numerical sum of the dealer's hand is exactly 16 and the reformulated numerical value of the player's hand falls within the range 17-21 inclusive.

9. The method of claim 1, wherein said step of resolving the side wager includes settling the player's side wager in favor of the dealer when the numerical sum of the dealer's hand is equal to the reformulated numerical value of the player's hand.

10. The method of claim 1, wherein said step of resolving the side wager includes pushing the player's side wager when the numerical sum of the dealer's hand is equal to the reformulated numerical value of the player's hand.

11. The method of claim 1, wherein said step of resolving the side wager includes settling the player's side wager in favor of the dealer when the dealer's hand is a Blackjack.

12. A method of playing a. wagering game similar to Blackjack using playing cards, comprising:
providing a playing surface, the playing surface including playing positions for a dealer and at least one player;
providing at least one standard deck of 52 playing cards with respective faces designated in ascending numerical sum 2-10, J, Q, K. A each in four suits; assigning a numerical value to each card, said numerical value being equivalent to the face value for cards designated 2-10, said numerical value being ten for cards designated J, Q, K, and said numerical value being one or eleven for cards designated A;
accepting a main wager from the player,
dealing the player and the dealer each two initial cards, said dealing step including arranging the two initial player cards face-up, said dealing step including arranging one initial dealer card face-up and the other initial dealer card face-down,
inviting the player to receive one or more additional cards into the player hand until either the player voluntarily stands on a numerical sum of card values less than 22 or the numerical sum of card values in the player hand exceeds 21,
forfeiting the player's main wager when the numerical sum of card values in the player hand exceeds 21,
accepting a side wager from the player, and then inviting the player to discard one card in the player hand to reformulate the numerical sum of card values in the player hand less the value of the one discarded card, the reformulated numerical sum being less than 22,
exposing the initial face-down dealer card,
calculating the numerical sum of the dealer hand, when the numerical sum is less than a predetermined threshold then requiring the dealer to receive an additional card and repeating said calculating and requiring steps, and when the numerical sum is equal to or greater than the predetermined threshold then resolving the side wager,
said step of resolving the side wager including comparing the numerical sum of the dealer's hand to the reformulated numerical sum of the player's hand, and settling the player's side wager in favor of the player when the reformulated numerical sum of the player's hand is higher than the numerical sum of the dealer's hand, and settling the player's side wager in favor of the dealer when the numerical sum of the dealer's hand is greater than the reformulated numerical value of the player's hand but less than 22.

13. The method of claim 12, wherein the main wager has a monetary value and the side wager has a monetary value less than the value of the main wager.

14. The method of claim 12, wherein the main wager has a monetary value and the side wager has a monetary value equal to the value of the main wager.

15. The method of claim 12, wherein said step of accepting the side wager occurs prior to said step of dealing the player and the dealer each two initial cards, and further including. returning the side wager when the player declines to discard one card in the player hand to reformulate the numerical sum of card values.

16. The method of claim 12, wherein said step of resolving the side wager includes comparing the numerical sum of the dealer's hand to the reformulated numerical sum of the player's hand, and settling the side wager in favor of the player when the reformulated numerical sum of the player's hand is higher than the numerical sum of the dealer's hand and less than 22 and the numerical sum of the dealer's hand is not 16.

17. The method of claim 12, wherein said step of resolving the side wager includes pushing the side wager when the numerical sum of the dealer's hand is exactly 16 and the reformulated numerical value of the player's hand falls within the range 17-21 inclusive.

18. The method of claim 12, wherein said step of resolving the side wager includes settling the player's side wager in favor of the dealer when the numerical sum of the dealer's hand is equal to the reformulated numerical value of the player's hand.

19. The method of claim 12, wherein said step of resolving the side wager includes pushing the player's side wager when the numerical sum of the dealer's hand is equal to the reformulated numerical value of the player's hand.

20. The method of claim 12, wherein said step of resolving the side wager includes settling the player's side wager in favor of the dealer when the dealer's hand is a Blackjack.
